(19) United States
(12) Patent Application Publication
(10) Pub. No.: US 2011/0115894 A1
(43) Pub. Date: May 19, 2011

(54) Device and method for diagnosis and monitoring of neural, opthalmologic and retinal disorders

(76) Inventor: Daniel Rogers Burnett, San Francisco, CA (US)

(21) Appl. No.: 12/927,644

(22) Filed: Nov. 19, 2010

Related U.S. Application Data
(60) Provisional application No. 61/281,558, filed on Nov. 19, 2009.
(60) Provisional application No. 61/403,681, filed on Sep. 20, 2010.

(51) Int. Cl. H04N 7/18

(52) U.S. Cl. 348/78; 348/E07.085

(57) ABSTRACT

Devices and methods to detect the sampling rate of the eye for diagnostic purposes involving: 1) exposing the eye to an analog signal or a digital signal with a varying speed/refresh rate, 2) recording the patient response, either manually or automatically, to detect the speed/refresh rate threshold for aliasing, 3) making a diagnosis with this information and/or correlating this information to a past reading to determine the trend in the function or status of the patient's retina, optic nerve or cerebral cortex.

### PRIORITY

This application claims priority to provisional patent application No. 61/281,558 filed Nov. 19, 2009 and provisional patent application No. 61/403,681 filed Sep. 20, 2010 the entire contents of which are incorporated herein by reference.

### FIELD OF THE INVENTION

The present invention relates to the field of diagnostic tests for retinal, neural and/or ophthalmologic disorders. More specifically, the present invention relates to a noninvasive, ophthalmologic test for detection of these disorders.

### BACKGROUND OF THE INVENTION

While there is very little information about it in the field of ophthalmology, and in the area of public knowledge at large, the eye processes visual stimuli in a digitized manner. Contrary to popular opinion, the eye does not process signals as a stream of analog information, but instead each individual rod and cone is triggered by an incoming visual stimulus (ie a photon) after which it is temporarily depleted of pigment in the spectra of the light received and this information is then sent via the optic nerve to the brain for processing. The rate of processing of visual information, then, depends on the rate of regeneration of the visual pigment in the retina in combination with the nerve conduction velocity of the optic nerve and its connecting neurons.

Under normal light circumstances, the rate of pigment regeneration is much greater than the rate of nerve repolarization, so in normal light the refresh rate of the eye (or sampling rate) is dependent largely on the conduction velocity and the refractory period associated with the neurons, within, leading into and leading out of the optic nerve. Thus, an easy to use test for the detection of the sampling rate of the eye would allow the user to track the condition of the eye in a variety of disorders that effect pigment regeneration and/or optic nerve signal processing. These conditions range from diabetes mellitus (particularly nerve damage associated with diabetes), multiple sclerosis, glaucoma, Guillain-Barre, and a variety of other disorders that affect can have an impact on the neural system and/or the optic nerve.

### SUMMARY OF THE INVENTION

A solution is provided to detect the sampling rate of the eye for diagnostic purposes involving: 1) exposing the eye to an analog signal or a digital signal with a varying speed/refresh rate, 2) recording the patient response, either manually or automatically, to detect the speed/refresh rate threshold for aliasing, 3) either making a diagnosis with this information or correlating this information to a past reading to determine the trend in the patient's nerve function and pigment regeneration rate. In one example, a spinning wheel with one or more spokes is show to the patient and the speed of the wheel (under correct lighting conditions) is shown to the patient. The refresh rate of the eye can then be determined by automatically or manually reporting the speed at which the wheel appears to “stand still” meaning the one or more spokes are making enough of a revolution such that one spoke appears where the other had been previously before the eye can process the next signal. This elegant test lends itself to automation, as well, when combined with eye-tracking technology to determine when the eye is following a moving bar (the spoke) or when it is fixed in one spot (meaning the spoke is standing still). In the digital manner, the refresh rate of a digital screen may be decreased in a step-wise fashion until the screen appears to flicker to the patient. The refresh rate at which the flicker occurs is less than the refresh rate of the eye, so if the test is performed in a stepwise manner, then the approximate refresh rate of the eye can be determined. The method and apparatus are particularly suited for noninvasively monitoring nerve function, optic nerve status and/or the rate of pigment regeneration.

### BRIEF DESCRIPTION OF THE DRAWINGS

The accompanying drawings, which are incorporated into and constitute a part of this specification, illustrate one or more embodiments of the present invention and, together with the detailed description, serve to explain the principles and implementations of the invention.

FIGS. 1a-b shows examples of an eyepiece for performing the diagnostic test and/or viewing a stimulus.

FIG. 2 shows one example of a side-view of an eye-piece for performing the diagnostic test and/or viewing a stimulus with manual reporting of patient response.

FIG. 3 shows one example of a side-view of an eye-piece for performing the diagnostic test and/or viewing a stimulus with automatic reporting of patient response.

FIG. 4 shows one example in which an analog stimulus may be presented to a user with manual or automatic reporting of user response.

FIG. 5 shows one example in which a digitized stimulus may be presented to a user with manual or automatic reporting of user response.

FIG. 6 is a block diagram of an embodiment of an apparatus for measuring the effective refresh rate of the optical sensory system-analog system with automatic reporting embodiment.

### DETAILED DESCRIPTION

Those of ordinary skill in the art will realize that the following detailed description of the present invention is illustrative only and is not intended to be in any way limiting. Other embodiments of the present invention will readily suggest themselves to such skilled persons having the benefit of this disclosure.

The present invention is based on a finding that the effective optical refresh rate varies from user to user, but is consistent for each user. Changes to the optical refresh rate for an individual user, then, may be indicative of pathology within the optical sensing system.

The pathology that may alter the Effective Optical Refresh Rate include loss of visual acuity (from any cause) or pathology related to retinal processing of images, conduction of impulses along the optic nerve or processing of these neural impulses within the occipital cortex of the brain. Detection of changes in the Effective Optical Refresh Rate, then, is not a specific tool, but may be sensitive enough to alert the clinician that further investigation is warranted to look for the source of potential pathology.

Aside from the acute detection of pathology once a baseline has been established, the Effective Optical Refresh Rate may also be used to detect subtle changes related to chronic conditions. These conditions range from acute or chronic blood glucose control, diabetic neuropathy, multiple sclerosis, glaucoma, Guillain-Barre, and any ophthalmic, neurologic, cerebral, autoimmune, vascular or other disorder that can have an impact on the Effective Optical Refresh Rate.

Reference will now be made in detail to implementations of the present invention as illustrated in the accompanying drawings. The same reference indicators will be used throughout the drawings and the following detailed description to refer to the same or like parts.

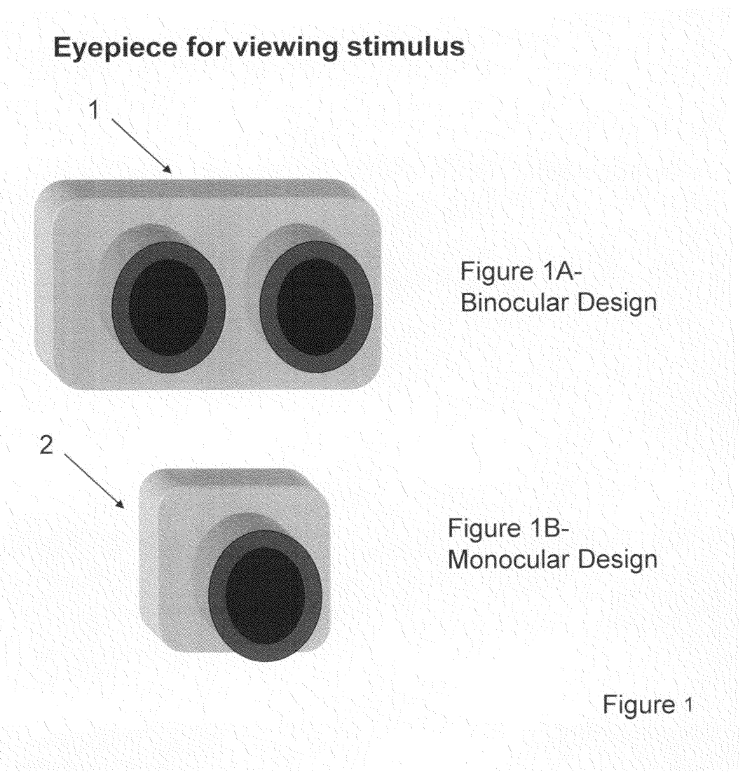

FIGS. 1a-b shows examples of an eyepiece for performing the diagnostic test and/or viewing a stimulus. The eyepiece 1 and 2 may portable or may a part of a clinical instrument. The eyepiece may be binocular 1, monocular 2 or not be necessary in all embodiments and a simple display, or simple mechanical design with a repeating display of a stimulus may be all that is required. The only requirement for the eyepiece or viewing apparatus is that the user be able to clearly see the stimulus and that the stimulus has an effective frequency that is greater than the Effective Optical Refresh Rate (approximately 15-50 Hz based on empirical tests).

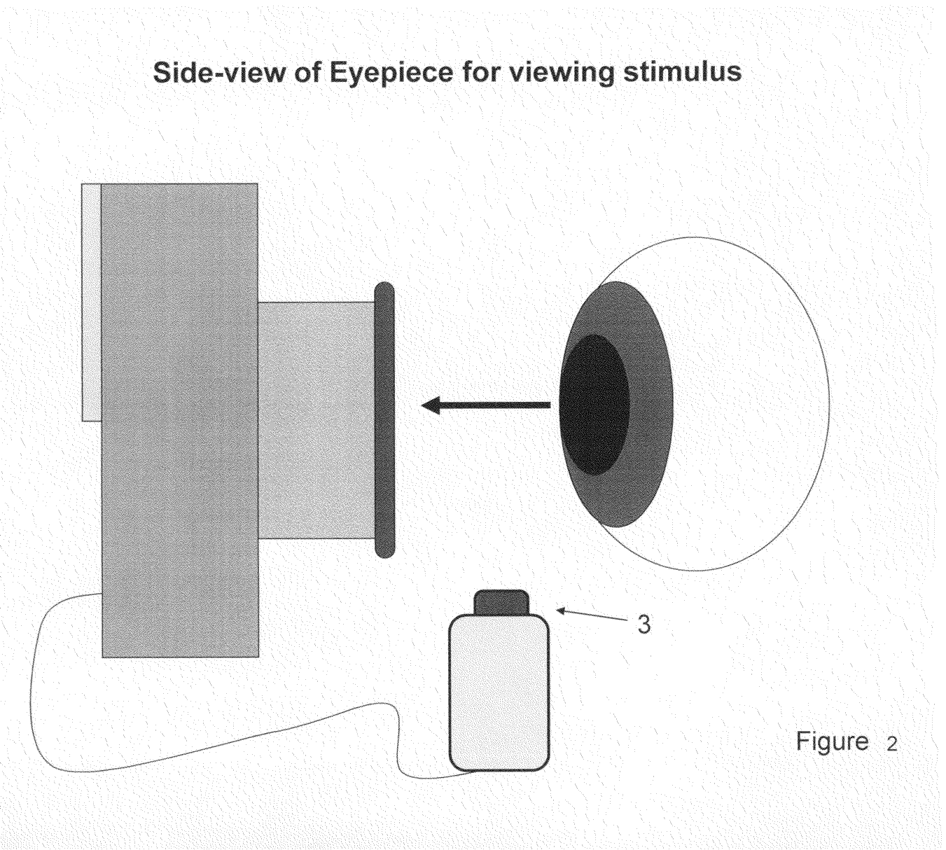

FIG. 2 shows one example of a side-view of an eye-piece for performing the diagnostic test and/or viewing a stimulus with manual reporting of patient response. In this embodiment, the patient may be asked to respond when the stimulus appears in a certain way to the patient. The simplest analog example involves a spinning wheel with spokes or a flashing stimulus of varying frequency. As the frequency (or RPMs) increase, the spokes blur, then slow down, then stand still once the RPM has been reached where the previous spoke reaches the exact position of the next spoke at the exact time that eye is ready to process its next signal. The patient, then, can be asked to press a button 3 or provide a response once the “spoke” on the wheel appears to stand still or the flashing stimulus appears to be continuous (or vice-versa if the stimulus is slowing down). This method can also be used with the presentation of digitized images and involves patient cooperation in order to achieve an accurate Effective Optical Refresh Rate.

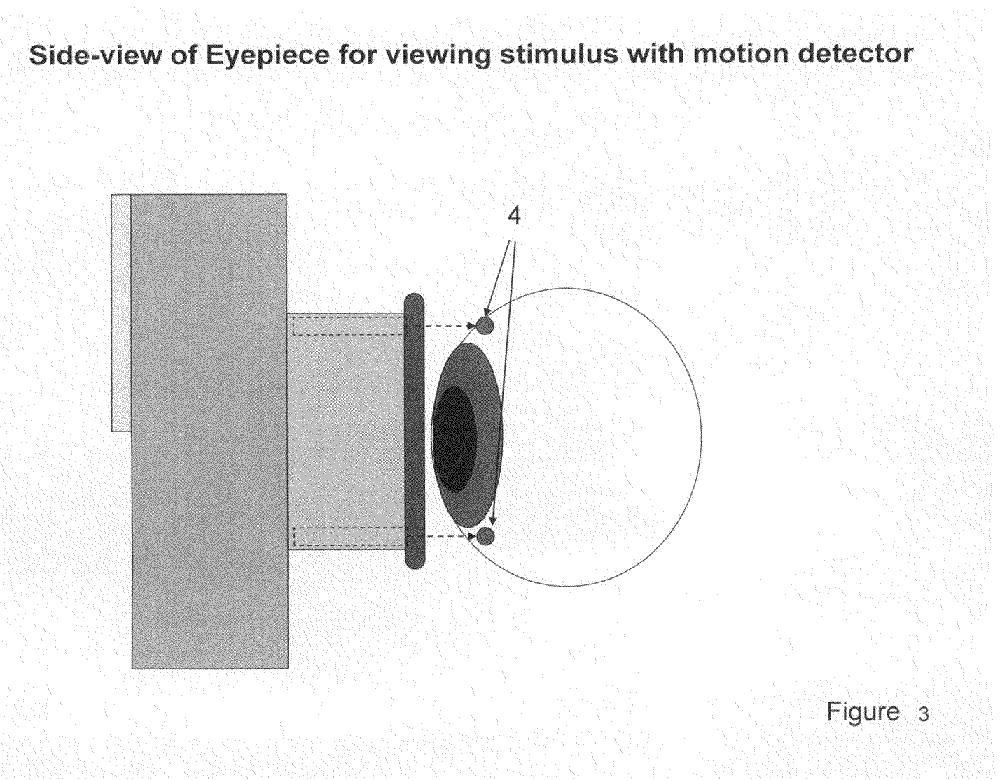

FIG. 3 shows one example of a side-view of an eye-piece for performing the diagnostic test and/or viewing a stimulus with automatic reporting of patient response. In this embodiment, the Effective Optical Refresh Rate may be detected using analog or digital stimuli, as well, but the reporting of the refresh rate may be done automatically. The simplest embodiment of this design involves the display of the desired stimulus (ie the spinning blade) then asking the user to follow the fan blade. Tracking of the eye (through laser, electrode, visual or other mechanism 4) will show the user tracking the fan blade until the frequency (or revolutions per second) match the Effective Optical Refresh Rate at which point the eye will stand still due to the appearance of a still fan blade to the user. In the digitized embodiment, one or more images may be presented to the user at varying, or various, frequencies. The patient may be asked to focus in the image that does not appear to “flicker” and when the eye motion is no longer detected the eye will be focused on one of the two images, the one whose frequency matches its refresh rate, preferentially. The patient may also use this technique along with the manual embodiment in FIG. 3 with multiple stimuli at various frequencies where the user is simply asked to pick the image which “flickers” the least. Their selection may then be correlated to their Effective Optical Refresh Rate. This embodiment may be used with analog or digitized stimuli with the only requirement being that the stimulus frequency be reported based on automated detection of eye movement.

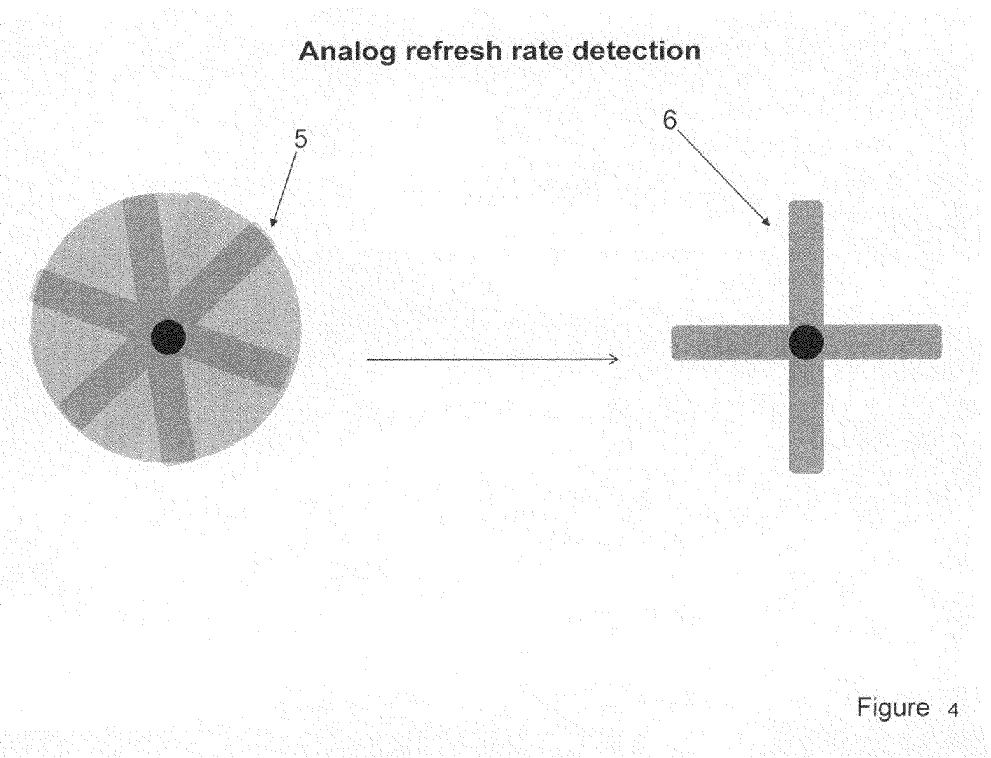

FIG. 4 shows one example in which an analog stimulus may be presented to a user with manual or automatic reporting of user response. This embodiment may be used with manual reporting (see FIG. 2) or eye motion detection (see FIG. 3). The patient may be asked to look at one spoke of the wheel and follow it, or the “wheel” may have only one spoke. Revolution of wheel is gradually increased 5, until the eye movement ceases at which point the revolutions per minute of the wheel may be used to calculate the sampling rate of the eye. Patient may simply report appearance of the wheel standing still 6, as well.

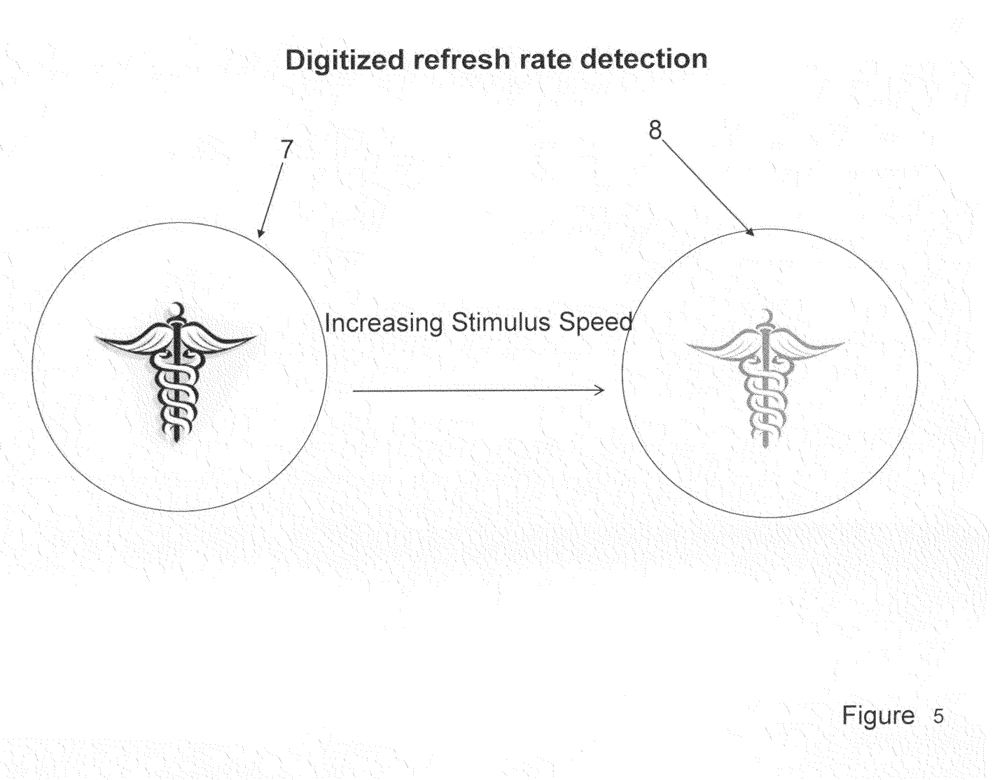

FIG. 5 shows one example in which a digitized stimulus may be presented to a user with manual or automatic reporting of user response. In one embodiment of this design, the refresh rate of the digital image starts above refresh rate of the eye then is gradually decreased. When the image begins to flicker, patient may report the flickering and the approximate sampling rate of the eye may be reported. This embodiment may be used with automated refresh rate scanning and patient feedback or automated detection based on eye movement and focus detection. Alternatively, multiple stimuli at varying frequencies (increasing in numerical order) may be presented at the same time and the patient may be asked to select the image with the lowest number that does not flicker. The frequency of this stimulus, then, is the Effective Optical Refresh Rate.

In yet another embodiment, the user may be exposed to flashing or flickering signal 7 at a certain frequency and be asked to report either when the signal begins to flash/flicker or stops flashing/flickering 8. For this embodiment of the device a light source, for example a rapidly flickering LED or other light source of known, constant intensity, may be presented to the user a rapid frequency (ie 60 Hz) then slowly decreased. The user may be asked to press a button or otherwise report when the light transitions from what appears to be a steady light to a flickering (or flashing) light. This test may also be accomplished in the opposite direction such that it may start flickering/flashing and the user may be asked to report when the flashing stops and the light appears constant. In the ideal embodiment, the two tests will be combined with the decelerating flicker followed by the accelerating flicker or vice-versa. In pilot studies of this device it has been found that the two tests almost always yield frequencies that are within 1 Hz of each other (particularly if one starts with the decelerating flashing LED test so that the user knows what the steady signal should look like). In order to appropriately perform this test the LED must be driven by a DC power source to prevent any aliasing caused by the alternating current itself. A flashing spot on a computer screen or digital display may be used, as well, assuming that the refresh rate of the computer screen or any digital display is such that it is at least two to three fold greater than the expected sampling frequency of the eye (which we have found to range from 20-60 Hz). In addition, in performing this test the user must be instructed to focus on a specific spot and remain focused on that spot (or one near it). A loss of focus and/or shifting of the eye may result in an alternate spot on the retina being exposed to the flashing stimulus which may skew the results. In addition, the rods in the periphery of the eye have significantly higher refresh rate than the cones in the center of the retina. Maintaining focus on the stimulus, or some object in the visual field that keeps the stimulus in a consistent spot on the retina, will help to ensure that the correct refresh rate is being measured. Based on initial tests, presenting the stimulus under identical lighting and stimulus intensity conditions are also both critical to achieving repeatable results. Combining the decelerating “report when it starts to blink” test with the accelerating “report when it stops blinking test” also drastically improves reliability of the test in that if there is a lack of agreement between the two results then the user may be prompted to test again. In pilot tests, once again, discrepant results have been able to be resolved with a retest. Any of the embodiments detailed above, but particularly this flashing stimulus, may be used to detect a variety of changes in the retinal, optic nerve or occipital cortex processing pathways. For retinal changes, this test may be used to detect acute changes in blood glucose which result in acute changes to retinal repigmentation rates. Macular degeneration and glaucoma are two other conditions that may be detected/monitored with this technology. Optic nerve conduction may be altered in multiple sclerosis, glaucoma, or other conditions which may also be detected with this technology. Lastly changes in the cerebral cortex itself may be detected such as central nervous system fatigue, cancer, demyelination, increased cerebral pressure, presence of a concussion, presence of a cerebral bleed, presence of a stroke or other disease of the cerebral cortex. In addition, alcohol or other drug intoxication may be detected due to multiple changes within this processing pathway. This may provide an excellent marker for legal intoxication for drivers to recognize their impairment.

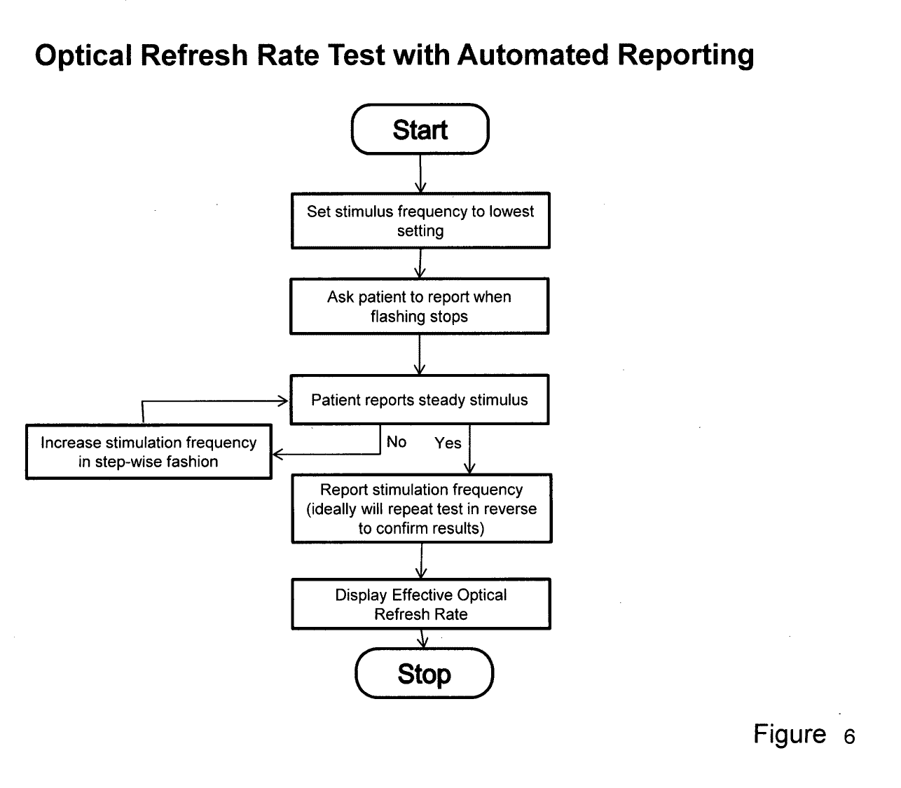

FIG. 6 is a block diagram of an embodiment of an apparatus for measuring the effective refresh rate of the optical sensory system-analog system with automatic reporting embodiment. In this embodiment, the frequency of the stimulus is increased and eye motion is tracked until the eye stands still. The Effective Optical Refresh Rate, then, is calculated from this frequency. The frequency may also be decreased from a value above the Effective Optical Refresh Rate and decreased until lack of eye motion is detected (or reported). Ideally the frequency will be gradually increased from a minimum so that aliasing will not cause falsely elevated results. Alternatively, a result may be obtained from the declining frequency method after which frequencies equivalent to ½, ⅓, ¼, etc. are presented to the patient to ensure that aliasing is not occurring. Even with the increasing frequency invention, presentation of integer fractions of the frequency reported as Effective Optical Refresh Rate will ensure that the frequency reported is accurate.

What is claimed is:

1. A device for measuring the optical refresh rate of vertebrates, comprising:
An analog or digital optical signal source with a varying speed/refresh rate, and
A detector to determine when the refresh rate has been reached, wherein
The signal source and the detector are both externally applied.

2. The device of claim 1, wherein:
the detector is a manually activated switch that is thrown by the user

3. The device of claim 1, wherein:
the detector automatically detects eye motion

4. The device of claim 3, wherein:
Eye motion is tracked and the presence of certain eye motions indicates the refresh rate

5. The device of claim 3 wherein:
The lack of eye motion indicates that the refresh rate has been reached

6. A method for measuring the optical refresh rate of vertebrates, comprising:
An analog or digital optical signal source with a varying speed/refresh rate, and
A detector to determine when the refresh rate has been reached, wherein
Said refresh rate may be used to monitor or diagnose one or more disorders.

7. The method of claim 6, wherein:
the detector is a manually activated switch that is thrown by the user once the appropriate stimulus is seen

8. The method of claim 6, wherein:
the detector automatically detects eye motion

9. The method of claim 8, wherein:
Eye motion is tracked and the presence of certain eye motions indicates the refresh rate

10. The method of claim 8, wherein:
The lack of eye motion indicates that the refresh rate has been reached

11. The method of claim 6, wherein:
Said disorder may include: acute or chronic blood glucose control, diabetic neuropathy, multiple sclerosis, glaucoma, optic neuropathy, Guillain-Barre, central nervous system fatigue, concussion, traumatic brain injury and/or any ophthalmic, neurologic, cerebral, autoimmune, vascular or other disorder that may have an impact on the Effective Optical Refresh Rate
